(19) United States
(12) Patent Application Publication
(10) Pub. No.: US 2026/0081828 A1
(43) Pub. Date: Mar. 19, 2026

(54) ZERO DOWNTIME SERVER UPGRADE

(71) Applicant: Avaya Management L.P., Morristown, NJ (US)

(72) Inventors: Tibor Lukac, Palm Beach Gardens, FL (US); Parag Mulay, Pune (IN); Dinesh Mude, Pune (IN); Jozsef Bodnar, Budapest (HU)

(21) Appl. No.: 19/060,633

(22) Filed: Feb. 22, 2025

(30) Foreign Application Priority Data
Sep. 18, 2024 (IN) 202411070509

(51) Int. Cl. H04L 41/082; H04L 65/1069; H04L 65/1096; H04L 65/1104

(52) U.S. Cl. CPC H04L 41/082; H04L 65/1069; H04L 65/1096; H04L 65/1104

(57) ABSTRACT

Servers commonly require upgrades. Servers, such as communication managers (CMs), may enter into a “deny new service” state and continue to process existing calls. Networked components receive an OPTIONS message, and any new calls are processed through a different communication manager. Existing calls are “ReHomed” via a SIP PUBLISH message to a different communication manager.

### CROSS-REFERENCE TO RELATED APPLICATION

The present application claims the benefit of priority to Provisional Indian Patent Application No. 202411070509, titled “MOVING CONTACT CENTER AGENTS, QUEUES, AND ASSOCIATED STATIONS TO A DIFFERENT SERVER NODE TO FACILITATE ZERO DOWNTIME (ZDT) UPGRADES TRANSITIONS,” filed on Sep. 18, 2024, and which is incorporated herein by reference in its entirety.

### FIELD OF THE DISCLOSURE

The present invention is related generally to systems and methods for monitoring and managing agent stations in a contact center.

### BACKGROUND

Telephony systems, such as a communication manager (herein “CM”), require maintenance, such as software upgrades, from time to time. This maintenance is disruptive to the users of such systems (e.g., stations, agents, customers, queues, etc.) as current services may be disrupted to perform the upgrade.

### SUMMARY

There is a need to preserve the agents'login state and ability to process calls during an upgrade or other CM downtime. Prior art solutions may move an agent node from a first server to a second server while preserving the data channel, such as the real-time protocol (“RTP”) of a Session Initiation Protocol (“SIP”) communication (e.g., “talkpath”). As a result, the call (real-time audio and optionally video) is preserved but not the ability to manipulate the call (e.g., transfer the call, conference the call, etc.). Additionally, agents would typically need to login to their endpoint again once the upgrade was complete and re-connect to the original server. As a result, prior art solutions remain problematic and require upgrades to be performed during off hours to reduce the impact of the upgrade.

These and other needs are addressed by the various embodiments and configurations of the present invention. The present invention can provide a number of advantages depending on the particular configuration. These and other advantages will be apparent from the disclosure of the invention(s) contained herein.

Embodiments herein enable upgrades to be performed at any time (e.g., busy or normal work shifts) as agent connects to customers are maintained as well as the agent's ability to manipulate calls during a server upgrade or other planned server outage.

As used herein, “node,” “server,” and “server node” may be used interchangeable to refer to a server or collection of servers performing a telephony task for calls between external, such as customers, and agents of a contact center. It should be appreciated that the terms “customer” and “agent” are used to differentiate external users (i.e., customers) from internal users (i.e., agents) and not to define or limit the user's herein to any particular type of role.

In one embodiment, an architecture is disclosed comprising a cluster of various application servers deployed together and distributing calls received by a center inbound call to agents, in-call features, call waiting queues, interactive voice response (IVR) applications, announcements, etc. Calls enter the system via a gateway and are proxied to appropriate available application servers to handle the calls and associated agent based on agent selection logic. When any application node is to be upgraded, it is put into a special zero down time (ZDT) state, such as a “ZDT—Deny New Service” state. Other network elements and application servers are made aware of through “SIP OPTIONS” monitoring. In this mode, other application nodes will allow existing call features to be handled by the “ZDT—Deny New Service” node but not issue any new calls/feature processing requests to that specific node. The “ZDT—Deny New Service” node itself also initiates a movement of the agents to a designated backup node, which starts accepting new inbound calls. During this movement, the “ZDT—Deny New Service” marked nodes issue SIP PUBLISH requests with a proprietary header that allows for migration of agents to the backup node and also conveys additional information (such as the agent's state) to this backup node. When all calls are drained from the “ZDT—Deny New Service” node and all agents moved off, then it can be upgraded without impacting any services. Once upgraded, a similar (reverse) procedure is used to move the agents and inbound calls back to the upgraded node. The procedure is repeated for each application node in the cluster until entire solutions are upgraded. During this upgrade procedure, the agents'hand-phones as well as soft-clients remain unaffected. This upgrade procedure shall not impact any customer's ongoing business operations.

In another embodiment, calls are drained off from an active CM and agents are moved to a backup CM while preserving agent state(s), etc. to facility ZDT upgrades.

In some aspects, the techniques described herein relate to a method for upgrading a first server, including: causing the first server to initiate a deny new service mode; migrating an endpoint networked to the first server to be networked to a second server; and in response to the endpoint being networked to the second server, performing an upgrade on the first server.

In some aspects, the techniques described herein relate to a method, wherein migrating the endpoint networked to the first server to be networked to the second server includes: generating a Session Initiation Protocol (SIP) PUBLISH message including an identifier of the endpoint, an action set to “ReHome”, and an identifier of the second server; and sending the SIP PUBLISH message to a session manager; and wherein the session manager processes the SIP PUBLISH message, and in response to receiving a call for the endpoint, generates a SIP INVITE message for the endpoint and sends the SIP INVITE message to cause the second server to connect to the endpoint.

In some aspects, the techniques described herein relate to a method, further including, upon completion of the upgrade on the first server, migrating the endpoint networked to the second server to be networked to the first server.

In some aspects, the techniques described herein relate to a method, wherein migrating the endpoint networked to the second server to be networked to the first server includes: generating a Session Initiation Protocol (SIP) PUBLISH message including an identifier of the endpoint, an action set to “ReHome”, and an identifier of the first server; and sending the SIP PUBLISH message to a session manager; and wherein the session manager processes the SIP PUBLISH message, and in response to receiving a call for the endpoint, generates a SIP INVITE message for the endpoint and sends the SIP INVITE message to the first server to cause the first server to connect to the endpoint.

In some aspects, the techniques described herein relate to a method, further including: generating a SIP OPTIONS message and sending the SIP OPTIONS message to the first server; in response to the SIP OPTIONS message, receiving a SIP 503 SERVICE UNAVAILABLE message from the first server; and in response to the SIP 503 SERVICE UNAVAILABLE message, causing a session manager to reroute new calls for the endpoint to the second server.

In some aspects, the techniques described herein relate to a method, wherein generating the SIP OPTIONS message and sending the SIP OPTIONS message is performed while at least one call is ongoing and including a customer communication device, an agent communication device and therebetween the first server.

In some aspects, the techniques described herein relate to a method, further including: receiving a second call addressed to an agent communication device; and in response to the SIP OPTIONS message, routing the second call to the agent communication device via the second server.

In some aspects, the techniques described herein relate to a method, wherein at least one of the first server or the second server includes a communication manager server.

In some aspects, the techniques described herein relate to a session manager, including: at least one processor coupled to a computer memory, the computer memory including instructions that, when read by the at least one processor, cause the at least one processor to perform: cause a first server to initiate a deny new service mode; migrate an endpoint networked to the first server to be networked to a second server; and in response the endpoint networked to the second server, perform an upgrade on the first server.

In some aspects, the techniques described herein relate to a session manager, wherein migrating the endpoint networked to the first server to be networked to the second server includes: generating a Session Initiation Protocol (SIP) PUBLISH message including an identifier of the endpoint, an action set to “ReHome”, and an identifier of the second server; and sending the SIP PUBLISH message to the session manager; and wherein the session manager processes the SIP PUBLISH message, and in response to receiving a call for the endpoint, generates a SIP INVITE message for the endpoint and sends the SIP INVITE message to cause the second server to connect to the endpoint.

In some aspects, the techniques described herein relate to a session manager, further including, upon completion of the upgrade on the first server, migrating the endpoint networked to the second server to be networked to the first server.

In some aspects, the techniques described herein relate to a session manager, wherein migrating the endpoint networked to the second server to be networked to the first server includes: generating a Session Initiation Protocol (SIP) PUBLISH message including an identifier of the endpoint, an action set to “ReHome”, and an identifier of the first server; and sending the SIP PUBLISH message to a session manager; and wherein the session manager processes the SIP PUBLISH message, and in response to receiving a call for the endpoint, generates a SIP INVITE message for the endpoint and sends the SIP INVITE message to the first server to cause the first server to connect to the endpoint.

In some aspects, the techniques described herein relate to a session manager, further including: before completion of the upgrade on the first server, generating a SIP OPTIONS message and sending the SIP OPTIONS message to the first server; in response to the SIP OPTIONS message, receiving a SIP 503 SERVICE UNAVAILABLE message from the first server; and in response to the SIP 503 SERVICE UNAVAILABLE message, causing a session manager to reroute new calls for the endpoint to the second server.

In some aspects, the techniques described herein relate to a session manager, wherein generating the SIP OPTIONS message and sending the SIP OPTIONS message are performed while at least one call is ongoing and including a customer communication device, an agent communication device and the first server is a portion of the at least one call therebetween.

In some aspects, the techniques described herein relate to a session manager, further including: receiving a second call addressed to an agent communication device; and in response to the SIP OPTIONS message, routing the second call to the agent communication device via the second server.

In some aspects, the techniques described herein relate to a session manager, wherein at least one of the first server or the second server includes a communication manager server.

In some aspects, the techniques described herein relate to a computer-readable medium maintained in a non-transitory computer memory that, when read by a processor, causes the processor to perform: causing a first server to initiate a deny new service mode; migrating an endpoint networked to the first server to be networked to a second server; and in response to the endpoint networked to the second server, performing an upgrade on the first server.

In some aspects, the techniques described herein relate to a computer-readable medium, wherein migrating the endpoint networked to the first server to be networked to the second server includes: generating a Session Initiation Protocol (SIP) PUBLISH message including an identifier of the endpoint, an action set to “ReHome”, and an identifier of the second server; and sending the SIP PUBLISH message to a session manager; and wherein the session manager processes the SIP PUBLISH message, and in response to receiving a call for the endpoint, generates a SIP INVITE message for the endpoint and sends the SIP INVITE message to cause the second server to connect to the endpoint.

In some aspects, the techniques described herein relate to a computer-readable medium, further including instructions to, upon completion of the upgrade on the first server, migrate the endpoint networked to the second server to be networked to the first server.

In some aspects, the techniques described herein relate to a computer-readable medium, wherein migrating the endpoint networked to the second server to be networked to the first server includes: generating a Session Initiation Protocol (SIP) PUBLISH message including an identifier of the endpoint, an action set to “ReHome”, and an identifier of the first server; and sending the SIP PUBLISH message to a session manager; and wherein the session manager processes the SIP PUBLISH message, and in response to receiving a call for the endpoint, generates a SIP INVITE message for the endpoint and sends the SIP INVITE message to the first server to cause the first server to connect to the endpoint.

A system on a chip (SoC) including any one or more of the above aspects or aspects of the embodiments described herein.

One or more means for performing any one or more of the above or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above aspects or aspects of the embodiments described herein, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The term “AADA” means Avaya Aura Distributed Architecture and is one embodiment of a horizontally scalable architecture built for flexibility and scale for a Private Branch Exchange (PBX)/Soft-switch.

The term “ACD”means Automatic Call Distribution.

The term “SBC” means Session Border Controller and is one embodiment of a network-edge element in a network that performs security/authentication/access control functions for Session Initial Protocol (“SIP”) endpoints.

The term “SM” means Session Manager. Session Manager performs the function of SIP registrar and proxy in Avaya's Aura Solution and similar distributed architectures.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,”“including,”and “having”can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S. C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIGS. 2A-2C depict a data processing flow in accordance with embodiments of the present disclosure; and

FIG. 3 depicts a device in a system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with the like reference number. When such a reference is made in the singular form, but without identification of the sub-reference identifier, it is a reference to one of the like numbered elements, but without limitation as to the particular one of the elements being referenced. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

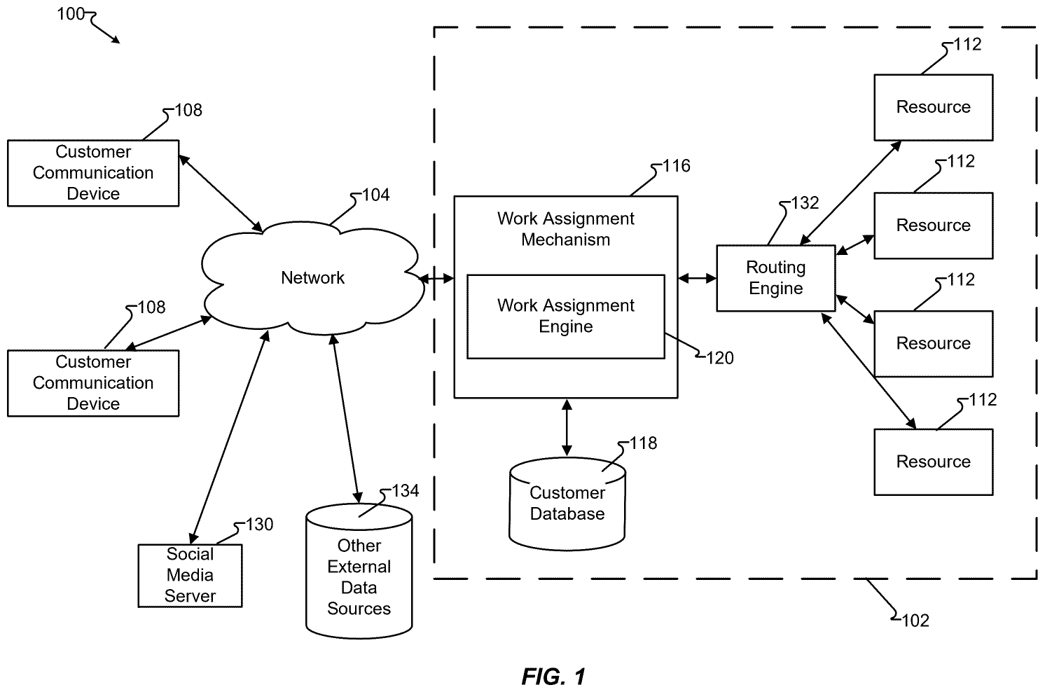

FIG. 1 depicts communication system 100 in accordance with at least some embodiments of the present disclosure. The communication system 100 may be a distributed system and, in some embodiments, comprises a communication network 104 connecting one or more customer communication devices 108 to a work assignment mechanism 116, which may be owned and operated by an enterprise administering contact center 102 in which a plurality of resources 112 is distributed to handle incoming work items (in the form of contacts) from customer communication devices 108.

Contact center 102 is variously embodied to receive and/or send messages that are themselves, or are associated with, work items and the processing and management (e.g., scheduling, assigning, routing, generating, accounting, receiving, monitoring, reviewing, etc.) of the work items by one or more resources 112. The work items are generally generated and/or received requests for a processing resource 112 embodied as, or a component of, an electronic and/or electromagnetically conveyed message. Contact center 102 may include more or fewer components than illustrated and/or provide more or fewer services than illustrated. The border indicating contact center 102 may be a physical boundary (e.g., a building, campus, etc.), legal boundary (e.g., a company, an enterprise, etc.), and/or logical boundary (e.g., resources 112 utilized to provide services to customers of contact center 102).

Furthermore, the border illustrating contact center 102 may be as illustrated or, in other embodiments, include alterations and/or more and/or fewer components than illustrated. For example, in other embodiments, one or more of resources 112, customer database 118, and/or other components may connect to routing engine 132 via communication network 104, such as when such components connect via a public network (e.g., Internet). In another embodiment, communication network 104 may be a private utilization of, at least in part, a public network (e.g., VPN); a private network located, at least partially, within contact center 102; or a mixture of private and public networks that may be utilized to provide electronic communication of components described herein. Additionally, it should be appreciated that components illustrated as external, such as social media server 130 and/or other external data sources 134, may be within contact center 102 physically and/or logically, but still be considered external for other purposes (e.g., system administration). For example, contact center 102 may operate social media server 130 (e.g., a website operable to receive user messages from customers and/or resources 112) as one means to interact with customers via their customer communication device 108.

Customer communication devices 108 are embodied as external to contact center 102 as they are under the more direct control of their respective user or customer. However, embodiments may be provided whereby one or more customer communication devices 108 are physically and/or logically located within contact center 102 and are still considered external to contact center 102, such as when a customer utilizes customer communication device 108 at a kiosk and attaches to a private network of contact center 102 (e.g., WiFi connection to a kiosk, etc.), within or controlled by contact center 102.

It should be appreciated that the description of contact center 102 provides at least one embodiment whereby the following embodiments may be more readily understood without limiting such embodiments. Contact center 102 may be further altered, added to, and/or subtracted from without departing from the scope of any embodiment described herein and without limiting the scope of the embodiments or claims, except as expressly provided.

Additionally, contact center 102 may incorporate and/or utilize social media server 130 and/or other external data sources 134 may be utilized to provide one means for a resource 112 to receive and/or retrieve contacts and connect to a customer of a contact center 102. Other external data sources 134 may include data sources, such as service bureaus, third-party data providers (e.g., credit agencies, public and/or private records, etc.). Customers may utilize their respective customer communication device 108 to send/receive communications utilizing social media server 130.

In accordance with at least some embodiments of the present disclosure, the communication network 104 may comprise any type of known communication medium or collection of communication media and may use any type of protocols to transport electronic messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through various telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VoIP) network, a cellular network, and any other type of packet-switched or circuit-switched network known in the art. In addition, it can be appreciated that the communication network 104 need not be limited to any one network type and instead may be comprised of a number of different networks and/or network types. As one example, embodiments of the present disclosure may be utilized to increase the efficiency of a grid-based contact center 102. Examples of a grid-based contact center 102 are more fully described in U.S. Pat. No. 8,964,958 issued on Feb. 24, 2015, to Steiner, the entire contents of which are hereby incorporated herein by reference. Moreover, the communication network 104 may comprise a number of different communication media, such as a coaxial cable, copper cable/wire, fiber-optic cable, antennas for transmitting/receiving wireless messages, and combinations thereof.

The customer communication devices 108 may correspond to a particular customer(s). In accordance with at least some embodiments of the present disclosure, a customer may utilize their customer communication device 108 to initiate a work item. Illustrative work items include, but are not limited to, a contact directed toward and received at a contact center 102, a web page request directed toward and received at a server farm (e.g., a collection of servers), a media request, an application request (e.g., a request for application resource location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof. In some embodiments, the communication may not necessarily be directed at the work assignment mechanism 116, but rather may be on some other server in the communication network 104 where it is harvested by the work assignment mechanism 116, which generates a work item for the harvested communication, such as social media server 130. An example of such a harvested communication includes a social media communication that is harvested by the work assignment mechanism 116 from a social media server 130 or network of servers. Exemplary architectures for harvesting social media communications and generating work items based thereon are described in U.S. patent application Ser. No. 12/784,369, Ser. No. 12/706,942, and Ser. No. 12/707,277, filed May 20, 2010, Feb. 17, 2010, and Feb. 17, 2010, respectively; each of which is hereby incorporated herein by reference in its entirety.

The format of the work item may depend upon the capabilities of the customer communication device 108 and/or the format of the communication. In particular, work items are logical representations of work to be performed in connection with servicing a communication received at contact center 102 (and, more specifically, the work assignment mechanism 116). The communication may be received and maintained at the work assignment mechanism 116, a switch or server connected to the work assignment mechanism 116, or the like, until a resource 112 is assigned to the work item representing that communication. At which point, the work assignment mechanism 116 passes the work item to a routing engine 132 to connect the customer communication device 108, which initiated the communication, with the assigned resource 112.

Although the routing engine 132 is depicted as being separate from the work assignment mechanism 116, the routing engine 132 may be incorporated into the work assignment mechanism 116 or its functionality may be executed by the work assignment engine 120.

In accordance with at least some embodiments of the present disclosure, the customer communication devices 108 may comprise any type of known communication equipment or collection of communication equipment. Examples of a suitable customer communication device 108 include, but are not limited to, a personal computer, laptop, Personal Digital Assistant (PDA), cellular phone, smart phone, telephone, or combinations thereof. In general, each customer communication device 108 may be adapted to support video, audio, text, and/or data communications with other customer communication devices 108 as well as the processing resources 112. The type of medium used by the customer communication device 108 to communicate with other customer communication devices 108 or processing resources 112 may depend upon the communication applications available on the customer communication device 108.

In accordance with at least some embodiments of the present disclosure, the work item is sent to a collection of processing resources 112 via the combined efforts of the work assignment mechanism 116 and routing engine 132. The resources 112 can either be completely automated resources (e.g., Interactive Voice Response (IVR) units, microprocessors, servers, or the like), human resources utilizing communication devices (e.g., human agents utilizing a computer, telephone, laptop, etc.), or any other resource known to be used in contact center 102.

As discussed above, the work assignment mechanism 116 and resources 112 may be owned and operated by a common entity in a contact center 102 format. In some embodiments, the work assignment mechanism 116 may be administered by multiple enterprises, each of which has its own dedicated resources 112 connected to the work assignment mechanism 116.

In some embodiments, the work assignment mechanism 116 comprises a work assignment engine 120, which enables the work assignment mechanism 116 to make intelligent routing decisions for work items. In some embodiments, the work assignment engine 120 is configured to administer and make work assignment decisions in a queueless contact center 102, as is described in U.S. Pat. No. 8,634,543 issued on Jan. 21, 2014, the entire contents of which are hereby incorporated herein by reference. In other embodiments, the work assignment engine 120 may be configured to execute work assignment decisions in a traditional queue-based (or skill-based) contact center 102.

The work assignment engine 120 and its various components may reside in the work assignment mechanism 116 or in a number of different servers or processing devices. In some embodiments, cloud-based computing architectures can be employed whereby one or more hardware components of the work assignment mechanism 116 are made available in a cloud or network such that they can be shared resources among a plurality of different users. Work assignment mechanism 116 may access customer database 118, such as to retrieve records, profiles, purchase history, previous work items, and/or other aspects of a customer known to contact center 102. Customer database 118 may be updated in response to a work item and/or input from resource 112 processing the work item.

It should be appreciated that one or more components of contact center 102 may be implemented in a cloud-based architecture in their entirety, or components thereof (e.g., hybrid), in addition to embodiments being entirely on-premises. In one embodiment, customer communication device 108 is connected to one of resources 112 via components entirely hosted by a cloud-based service provider, wherein processing and data storage hardware components may be dedicated to the operator of contact center 102 or shared or distributed among a plurality of service provider customers, one being contact center 102.

In one embodiment, a message is generated by customer communication device 108 and received via communication network 104 at work assignment mechanism 116. The message received by a contact center 102, such as at the work assignment mechanism 116, is generally, and herein, referred to as a “contact.” Routing engine 132 routes the contact to at least one of resources 112 for processing.

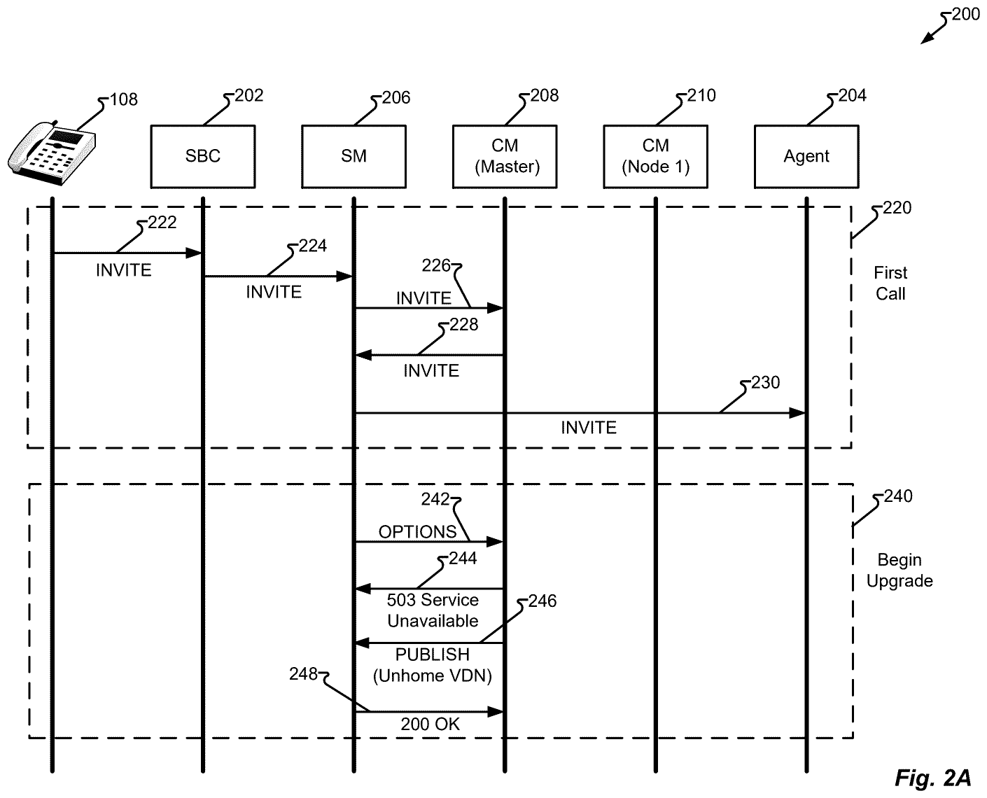

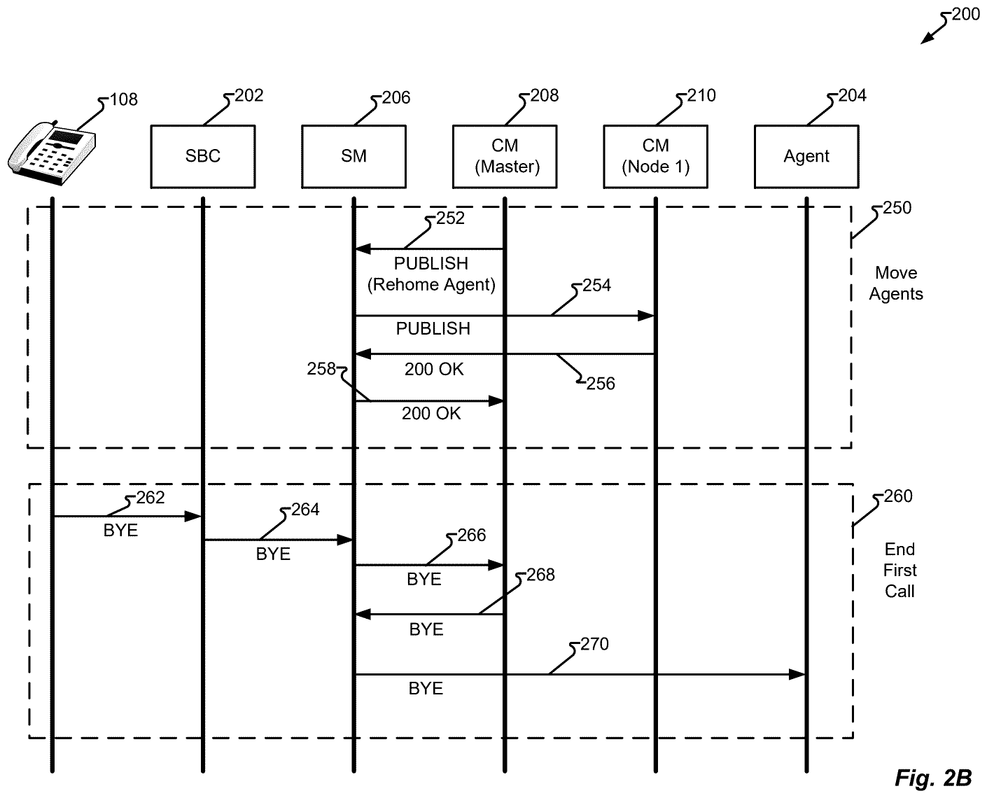

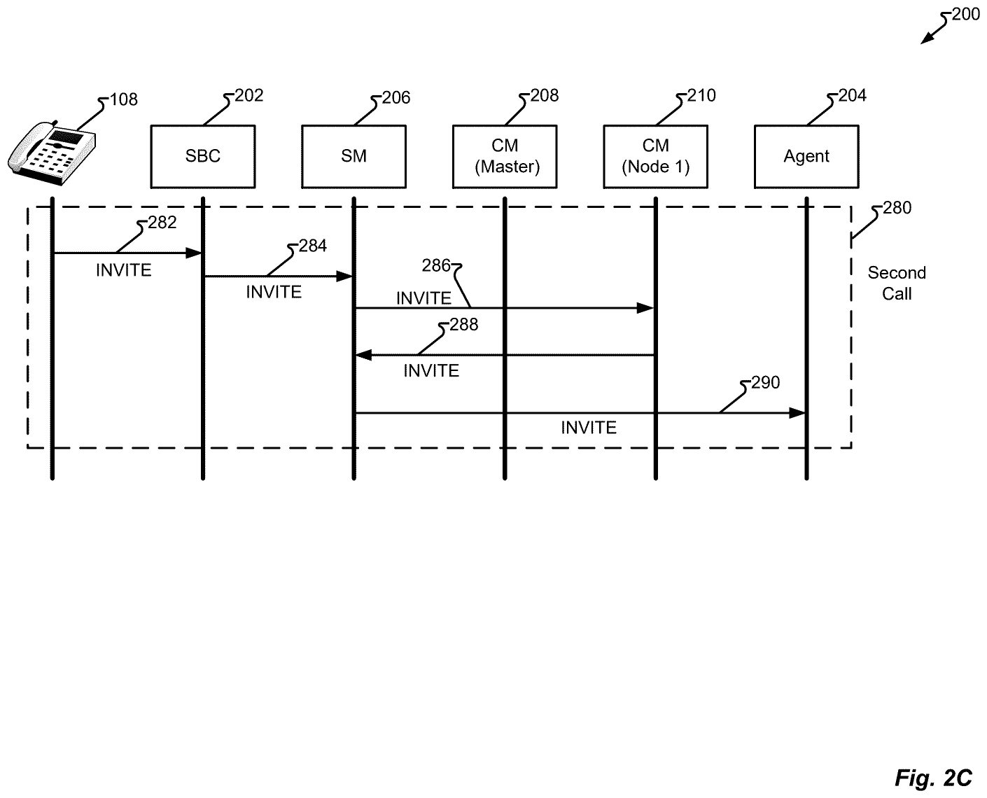

FIGS. 2A-2C depicts data processing flow 200 in accordance with embodiments of the present disclosure. It should be appreciated that the messages herein, and those of data processing flow 200 in particular, are compliant with SIP protocol standards, such as “SIP: Session Initiation Protocol” from the Network Working Group of the Internet Society, June 2002, known as “RFC 3261”, which is incorporated herein by reference and available at www.datatracker.ietf.org/doc/html/rfc3261.

Generally, process flow comprises block 220, initiating a first call; block 240, beginning an upgrade; block 250, moving agent(s) to a different communication manager; block 260 ending the first call; and block 280, initiating a second call.

In one embodiment, processing steps in block 220 are performed such as when a customer uses customer communication device 108 to initiate a call with contact center 102. The call may be originated as INVITE message 222, which may further include the destination (e.g., the address or identifier of agent endpoint 204). INVITE message 222 is received by session border controller (“SBC”) 202 and, as a result, SBC 202 sends INVITE message 224 to session manager (“SM”) 206. The target user (utilizing agent endpoint 204) may be is identified by SM 206 as being “homed” on communication manager (“CM”) master 208 and, accordingly, SM 206 sends INVITE message 226 to CM master 208. CM master 208 replies with INVITE message 228 sent to SM 206. SM 206 then sends INVITE message 230 to agent endpoint 204.

In another embodiment, processing steps in block 240 are performed to begin an upgrade. CM master 208 is designated for an upgrade and, in response, SM 206 sends OPTIONS message 242 to CM master 208. In response, CM master 208 replies with message 244, such as “503 Service Unavailable (Deny New Service)”. Additionally, CM master 208 sends message 246, such as “PUBLISH (Unhome VDN). As a result of message 244 and/or 246, other network elements, which may include but are not limited to SM 206, are now aware that CM master 208 is in a “ZDT—Deny New Service” state. SM 206 responds with message 248, such as “200 OK”.

In another embodiment, processing steps in block 250 are performed to move agents to a different CM, such as CM Node 1 (210). CM master 208 sends message 252, such as “PUBLISH (Rehome Agent)” to SM 206. SM 206 respond with message 254, such as “PUBLISH” to CM node 1 (210) to notify CM node 1 (210) that agent nodes (e.g., agent endpoint 204) is being rehomed to CM node 1 (210). CM node 1 (210) responds with message 256, such as “200 OK” and, in response, SM 206 informs CM master 208 that the agent node has been rehomed with message 258, such as “200 OK.”

In another embodiment, processing steps in block 260 are performed to end the first call. When customer device 108 terminates the call, BYE message 262 is sent from customer communication device 108 to SBC 262. In response SBC 202 sends BYE message 264 to SM 206. In response SM 206 sends BYE message 266 to CM master 208, which responds with BYE message 268 back to SM 206. SM 206 then sends BYE message 270 to agent endpoint 204.

In another embodiment, processing steps in block 280 are performed to initiate a second call. A customer uses customer communication device 108 (which may be the same or a different customer using the same or a different customer communication device 108 utilized in block 220) to initiate a call with contact center 102. The call may be originated as INVITE message 282, which may further include the destination (e.g., the address or identifier of agent endpoint 204). INVITE message 282 is received by SBC 202 and, as a result, SBC 202 sends INVITE message 284 to SM 206. The target user (utilizing agent endpoint 204) may be is identified by SM 206 as being “homed” on CM Node 1 (210) and, accordingly, SM 206 sends INVITE message 286 to CM Node 1 (210). CM Node 1 (210) replies with INVITE message 288 sent to SM 206. SM 206 then sends INVITE message 290 to agent endpoint 204.

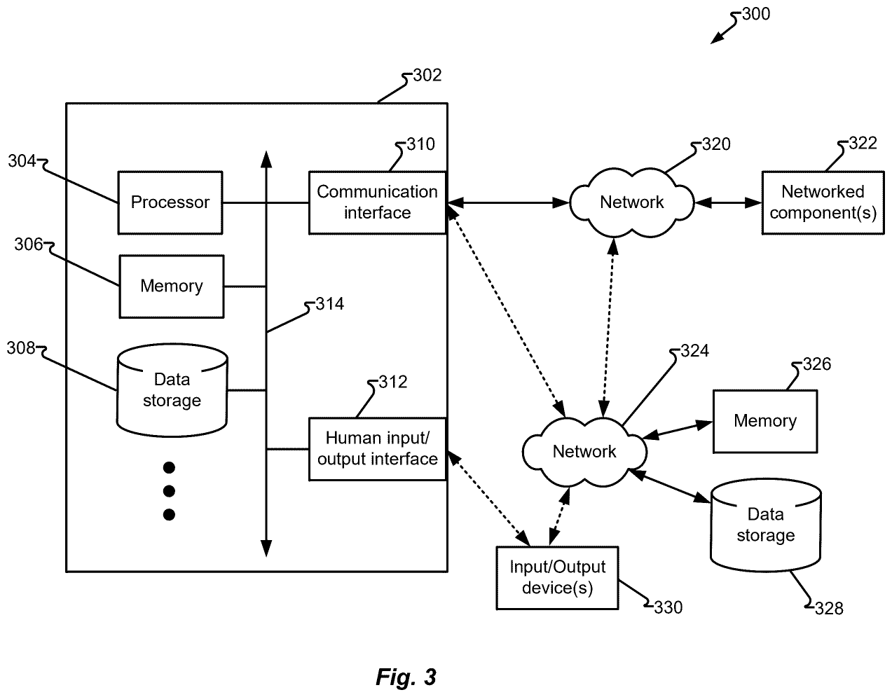

FIG. 3 depicts device 302 in system 300 in accordance with embodiments of the present disclosure. In one embodiment, a server such as one or more of SBC 202, SM 206, CM master 208, CM node 1 (210) and/or customer communication device 108 and/or agent endpoint 204 may be embodied, in whole or in part, as device 302 comprising various components and connections to other components and/or systems. The components are variously embodied and may comprise processor 304. The term “processor,” as used herein, refers exclusively to electronic hardware components comprising electrical circuitry with connections (e.g., pin-outs) to convey encoded electrical signals to and from the electrical circuitry. Processor 304 may comprise programmable logic functionality, such as determined, at least in part, from accessing machine-readable instructions maintained in a non-transitory data storage, which may be embodied as circuitry, on-chip read-only memory, computer memory 306, data storage 308, etc., that cause the processor 304 to perform the steps of the instructions. Processor 304 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 314, executes instructions, and outputs data, again such as via bus 314. In other embodiments, processor 304 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 304 is a non-transitory computing device (e.g., electronic machine comprising circuitry and connections to communicate with other components and devices). Processor 304 may operate a virtual processor, such as to process machine instructions not native to the processor (e.g., translate the VAX operating system and VAX machine instruction code set into Intel® 9xx chipset code to enable VAX-specific applications to execute on a virtual VAX processor). However, as those of ordinary skill understand, such virtual processors are applications executed by hardware, more specifically, the underlying electrical circuitry and other hardware of the processor (e.g., processor 304). Processor 304 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 304, device 302 may utilize computer memory 306 and/or data storage 308 for the storage of accessible data, such as instructions, values, etc. Communication interface 310 facilitates communication with components, such as processor 304 via bus 314 with components not accessible via bus 314 and may be embodied as a network interface (e.g., ethernet card, wireless networking components, USB port, etc.). Communication interface 310 may be embodied as a network port, card, cable, or other configured hardware device. Additionally or alternatively, human input/output interface 312 connects to one or more interface components to receive and/or present information (e.g., instructions, data, values, etc.) to and/or from a human and/or electronic device. Examples of input/output devices 330 that may be connected to input/output interface include, but are not limited to, keyboard, mouse, trackball, printers, displays, sensor, switch, relay, speaker, microphone, still and/or video camera, etc. In another embodiment, communication interface 310 may comprise, or be comprised by, human input/output interface 312. Communication interface 310 may be configured to communicate directly with a networked component or configured to utilize one or more networks, such as network 320 and/or network 324.

Network 104 may be embodied, in whole or in part, as network 320. Network 320 may be a wired network (e.g., Ethernet), wireless (e.g., WiFi, Bluetooth, cellular, etc.) network, or combination thereof and enable device 302 to communicate with networked component(s) 322. In other embodiments, network 320 may be embodied, in whole or in part, as a telephony network (e.g., public switched telephone network (PSTN), private branch exchange (PBX), cellular telephony network, etc.).

Additionally or alternatively, one or more other networks may be utilized. For example, network 324 may represent a second network, which may facilitate communication with components utilized by device 302. For example, network 324 may be an internal network to a business entity or other organization, such as contact center 102, whereby components are trusted (or at least more so) than networked components 322, which may be connected to network 320 comprising a public network (e.g., Internet) that may not be as trusted.

Components attached to network 324 may include computer memory 326, data storage 328, input/output device(s) 330, and/or other components that may be accessible to processor 304. For example, computer memory 326 and/or data storage 328 may supplement or supplant computer memory 306 and/or data storage 308 entirely or for a particular task or purpose. As another example, computer memory 326 and/or data storage 328 may be an external data repository (e.g., server farm, array, “cloud,” etc.) and enable device 302, and/or other devices, to access data thereon. Similarly, input/output device(s) 330 may be accessed by processor 304 via human input/output interface 312 and/or via communication interface 310 either directly, via network 324, via network 320 alone (not shown), or via networks 324 and 320. Each of computer memory 306, data storage 308, computer memory 326, and data storage 328 comprises a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 330 may be a router, a switch, a port, or other communication component such that a particular output of processor 304 enables (or disables) input/output device 330, which may be associated with network 320 and/or network 324, to allow (or disallow) communications between two or more nodes on network 320 and/or network 324. For example, a connection between one particular customer, using a particular customer communication device 108, may be enabled (or disabled) with a particular networked component 322 and/or particular resource 112. Similarly, one particular networked component 322 and/or resource 112 may be enabled (or disabled) from communicating with a particular other networked component 322 and/or resource 112, including, in certain embodiments, device 302 or vice versa. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components by, in one or more embodiments, voltages in memory circuits, configuration of switching circuits, and/or by selective use of particular logic gate circuits. Additionally or alternatively, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessors may be integrated into a single processing appliance (e.g., computer, server, blade, etc.) or located entirely, or in part, in a discrete component and connected via a communications link (e.g., bus, network, backplane, etc. or a plurality thereof).

Examples of general-purpose microprocessors may comprise a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, a first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.” Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users'premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A method for upgrading a first server, comprising:
causing the first server to initiate a deny new service mode;
migrating an endpoint networked to the first server to be networked to a second server; and
in response to the endpoint being networked to the second server, performing an upgrade on the first server.

2. The method of claim 1, wherein migrating the endpoint networked to the first server to be networked to the second server comprises:
generating a Session Initiation Protocol (SIP) PUBLISH message comprising an identifier of the endpoint, an action set to “ReHome”, and an identifier of the second server; and
sending the SIP PUBLISH message to a session manager; and
wherein the session manager processes the SIP PUBLISH message, and in response to receiving a call for the endpoint, generates a SIP INVITE message for the endpoint and sends the SIP INVITE message to cause the second server to connect to the endpoint.

3. The method of claim 1, further comprising, upon completion of the upgrade on the first server, migrating the endpoint networked to the second server to be networked to the first server.

4. The method of claim 3, wherein migrating the endpoint networked to the second server to be networked to the first server comprises:
generating a Session Initiation Protocol (SIP) PUBLISH message comprising an identifier of the endpoint, an action set to “ReHome”, and an identifier of the first server; and
sending the SIP PUBLISH message to a session manager; and
wherein the session manager processes the SIP PUBLISH message, and in response to receiving a call for the endpoint, generates a SIP INVITE message for the endpoint and sends the SIP INVITE message to the first server to cause the first server to connect to the endpoint.

5. The method of claim 1, further comprising:
generating a SIP OPTIONS message and sending the SIP OPTIONS message to the first server;
in response to the SIP OPTIONS message, receiving a SIP 503 SERVICE UNAVAILABLE message from the first server; and
in response to the SIP 503 SERVICE UNAVAILABLE message, causing a session manager to reroute new calls for the endpoint to the second server.

6. The method of claim 5, wherein generating the SIP OPTIONS message and sending the SIP OPTIONS message is performed while at least one call is ongoing and comprising a customer communication device, an agent communication device and therebetween the first server.

7. The method of claim 5, further comprising:
receiving a second call addressed to an agent communication device; and
in response to the SIP OPTIONS message, routing the second call to the agent communication device via the second server.

8. The method of claim 1, wherein at least one of the first server or the second server comprises a communication manager server.

9. A session manager, comprising:
at least one processor coupled to a computer memory, the computer memory comprising instructions that, when read by the at least one processor, cause the at least one processor to perform:
cause a first server to initiate a deny new service mode;
migrate an endpoint networked to the first server to be networked to a second server; and
in response the endpoint networked to the second server, perform an upgrade on the first server.

10. The session manager of claim 9, wherein migrating the endpoint networked to the first server to be networked to the second server comprises:
generating a Session Initiation Protocol (SIP) PUBLISH message comprising an identifier of the endpoint, an action set to “ReHome”, and an identifier of the second server; and
sending the SIP PUBLISH message to the session manager; and
wherein the session manager processes the SIP PUBLISH message, and in response to receiving a call for the endpoint, generates a SIP INVITE message for the endpoint and sends the SIP INVITE message to cause the second server to connect to the endpoint.

11. The session manager of claim 9, further comprising, upon completion of the upgrade on the first server, migrating the endpoint networked to the second server to be networked to the first server.

12. The session manager of claim 11, wherein migrating the endpoint networked to the second server to be networked to the first server comprises:
generating a Session Initiation Protocol (SIP) PUBLISH message comprising an identifier of the endpoint, an action set to “ReHome”, and an identifier of the first server; and
sending the SIP PUBLISH message to a session manager; and
wherein the session manager processes the SIP PUBLISH message, and in response to receiving a call for the endpoint, generates a SIP INVITE message for the endpoint and sends the SIP INVITE message to the first server to cause the first server to connect to the endpoint.

13. The session manager of claim 9, further comprising:
before completion of the upgrade on the first server, generating a SIP OPTIONS message and sending the SIP OPTIONS message to the first server;
in response to the SIP OPTIONS message, receiving a SIP 503 SERVICE UNAVAILABLE message from the first server; and
in response to the SIP 503 SERVICE UNAVAILABLE message, causing a session manager to reroute new calls for the endpoint to the second server.

14. The session manager of claim 13, wherein generating the SIP OPTIONS message and sending the SIP OPTIONS message are performed while at least one call is ongoing and comprising a customer communication device, an agent communication device and the first server is a portion of the at least one call therebetween.

15. The session manager of claim 13, further comprising:
receiving a second call addressed to an agent communication device; and
in response to the SIP OPTIONS message, routing the second call to the agent communication device via the second server.

16. The session manager of claim 9, wherein at least one of the first server or the second server comprises a communication manager server.

17. A computer-readable medium maintained in a non-transitory computer memory that, when read by a processor, causes the processor to perform:
causing a first server to initiate a deny new service mode;
migrating an endpoint networked to the first server to be networked to a second server; and
in response to the endpoint networked to the second server, performing an upgrade on the first server.

18. The computer-readable medium of claim 17, wherein migrating the endpoint networked to the first server to be networked to the second server comprises:
generating a Session Initiation Protocol (SIP) PUBLISH message comprising an identifier of the endpoint, an action set to “ReHome”, and an identifier of the second server; and
sending the SIP PUBLISH message to a session manager; and
wherein the session manager processes the SIP PUBLISH message, and in response to receiving a call for the endpoint, generates a SIP INVITE message for the endpoint and sends the SIP INVITE message to cause the second server to connect to the endpoint.

19. The computer-readable medium of claim 17, further comprising instructions to, upon completion of the upgrade on the first server, migrate the endpoint networked to the second server to be networked to the first server.

20. The computer-readable medium of claim 19, wherein migrating the endpoint networked to the second server to be networked to the first server comprises:
generating a Session Initiation Protocol (SIP) PUBLISH message comprising an identifier of the endpoint, an action set to “ReHome”, and an identifier of the first server; and
sending the SIP PUBLISH message to a session manager; and
wherein the session manager processes the SIP PUBLISH message, and in response to receiving a call for the endpoint, generates a SIP INVITE message for the endpoint and sends the SIP INVITE message to the first server to cause the first server to connect to the endpoint.
